(19) United States
(12) Patent Application Publication
(10) Pub. No.: US 2008/0125080 A1
(43) Pub. Date: May 29, 2008

(54) Method and system for value transfer between mobile-phone users

(76) Inventor: Mark E. Phillips, Seattle, WA (US)

Correspondence Address: OLYMPIC PATENT WORKS PLLC, P.O. BOX 4277, SEATTLE, WA, 98104, US

(21) Appl. No.: 11/725,181

(22) Filed: Mar. 16, 2007

Related U.S. Application Data
(60) Provisional application No. 60/851,466, filed on Oct. 13, 2006.

(51) Int. Cl. H04M 11/00

(52) U.S. Cl. 455/405

(57) ABSTRACT

Embodiments of the present invention are directed to enhancing mobile-phone networks to allow mobile-phone users to exchange value among themselves through mobile-phone networks. In certain embodiments of the present invention, mobile-phone users exchange value among themselves by exchanging minutes of mobile-phone usage purchased by the mobile-phone users from their carrier-service providers. Minutes-based value exchanges are particularly useful in developing countries, where users may not have bank accounts, and where the overheads associated with traditional financial transactions are too great to allow for use of traditional-financial-transaction services to carry out the many relatively low-value transactions in which mobile-phone users may wish to engage. The exchange of minutes among mobile-phone users, as well as between mobile-phone users and commercial enterprises, can facilitate currently existing small-value-exchange markets as well as create whole new types of markets previously impractical due to the high overheads associated with value exchanges through traditional traditional-financial-transaction services.

### CROSS REFERENCE TO RELATED APPLICATION

This application claims the benefit of U.S. Provisional Application No. 60/851,466, filed Oct. 13, 2006.

### TECHNICAL FIELD

The present invention is related to transaction processing systems and wireless communications systems and, in particular, to a method and system for providing mobile-phone-user-to-mobile-phone-user value exchanges that can, in turn, serve as the basis for commercial and financial transactions.

### BACKGROUND OF THE INVENTION

Worldwide use of wireless communications, in particular mobile-phone-based communications, has expanded dramatically during the past decade. There are currently billions of cell phones in use, and shipments of new cell phones may soon exceed one billion units per year. Convenience of mobile communications, fierce competition from a carrier-service providers resulting in great economic efficiency in provision of carrier services to users, and the ability to quickly and inexpensively interconnect users via cell phones in developing countries lacking land-line infrastructure, have all contributed to the rapid commercial acceptance of mobile-phone technology throughout the world.

FIG. 1 shows a relatively high-level diagram of a generalized mobile-phone communications system. There are many different types of mobile-phone systems and technologies. FIG. 1 is intended to show, at very high level, basic features of one such system, the global system for mobile communications (“GSM”), currently servicing over two billion mobile-phone users in more than 212 countries and territories throughout the world. GSM is a second-generation mobile-phone system, supporting both digital-data exchange and speech channels. Mobile phones, such as mobile phones 102 and 104 in FIG. 1, communicate with the GSM system via radio-frequency signals 106 and 108. Mobile phones communicate via radio-frequency signals with base transceiver stations (“BTSs”) 110 and 112 that each comprises equipment for transmitting and receiving radio signals, including antennas and communications equipment for transforming the radio-frequency-encoded information into pulse-code-modulated (“PCM”) digital information that can be exchanged with a base-station controller 114, and transforming PCM-encoded information back to radio-frequency signals for transmission to mobile phones.

The GSM system supports both voice signals and packet-based information exchange, with packet-based information exchange controlled by a packet-control unit 116. Voice data is transmitted by the base station to a mobile switching center 118, and the packet-based data is exchanged between the packet-control unit 116 and general-packet-radio-services (“GPRS”) hardware 120. Voice data can be routed by the mobile switching center to the same or different base stations for broadcast to mobile phones, routed to different mobile-phone networks, and routed into the public switched telephone network 122 for transmission to land-line-based telephones 124. Packet-based data can be routed by the GPRS into digital communications networks and eventually, via the Internet 124, to computers and other devices that communicate via packet-based protocols 126. Both the mobile switching center and GPRS hardware can exchange data through an SS7 network 126, and, through the SS7 network, can access a home location register, authentication center, and equipment identity register 128.

The base station controller (“BSC”) 114 allocates radio channels, controls handovers of communications links from one BTS to another, and can, in certain implementations, serve as switching centers. A BSC, along with multiple BTSs and a packet-control unit, together comprise a base station substation (“BSS”) 130. A mobile switching center, home location register, authentication center, and equipment identity register, together with PSTN and SS7 network connections, comprise a network switching subsystem (“NSS”) 132. The NSS carries out switching functions and manages communications between mobile phones and the PSTN. The architecture of the NSS resembles a telephone exchange, with additional functionality needed for managing mobile end points. The NSS is generally considered to handle circuit-switched information exchange, including voice data, short-messaging services (“SMS”) for exchange of text-based messages between mobile phones, and circuit-switched data calls.

The home location register is a central database that contains information describing each mobile-phone subscriber of the carrier service to which the network switching subsystem 132 belongs. Mobile-phone subscribers, or users, are identified via a subscriber identity module (“SIM”), or SIM card, that is inserted by the user into the user's mobile phone. The SIM card contains information identifying the user, subscription information, and the user's phonebook. The SIM card also include cryptography-related secret information that allows for encryption of voice signals and data transfers exchanged between a user's mobile phone and a base station substation. The home location register stores details of each user's SIM card and SIM-card contents, and manages mapping of users to geographical locations, so that calls can be directed to users and so that users can make calls from the users' current locations. The authentication center authenticates the SIM card of a mobile phone attempting to connect to the GSM network, and generates encryption keys for each connection to allow voice and data signals to be encrypted. The authentication center provides information to the mobile switching center 118 that allows the mobile switching center to authenticate users and to allow the MSC to carry out secure information exchanges with a mobile phone. The mobile phones 102 and 104 are essentially computing devices that run operating systems for supporting various applications and mobile-phone user interfaces.

FIG. 2 illustrates a useful abstraction of generalized mobile-phone systems and platforms. As shown in FIG. 2, mobile-phone systems 202 essentially provide the communications equipment and computing hardware that allows a cell phone user, via a first cell phone 204, to connect to, and exchange voice and digital data with, a second user via a second cell phone 206 or land line-based phone 208. Applications running on mobile phones can provide computer-like user interfaces to cell phone users via displays (e.g. display 210 of cell phone 204), and can receive data from users and display received data to users through the displayed user interfaces. Mobile-phone users can exchange text messages through the short-message service and can, in certain cases, download and read email from personal computers and interface to other software applications that transmit and receive digital data through the mobile-phone network.

While the mobile-phone system was initially designed and implemented primarily for user-to-user voice communication, the mobile-phone system was then enhanced to allow for exchange of other types of digital information. More recently, mobile-phone systems, in cooperation with various commercial and financial institutions, have begun to offer an array of additional services to mobile-phone users. FIG. 3 illustrates a small number of the various additional services that a mobile-phone user, or carrier-service subscriber, can currently access via the user's cell phone and the mobile-phone network. A mobile-phone user can access the mobile-phone-user's bank 302, which provides to the mobile-phone user a variety of banking services, including access to the user's bank accounts, account management, and various funds-transfer services. In certain mobile-phone systems, a mobile-phone user can access vending services 304, such as vending machines, in order to pay for vending services through the mobile-phone-user's carrier-service account. Thus, vending-service charges are billed to the user by the user's carrier service. Currently, mobile-phone users may access, using their mobile phones, a variety of different commercial entities in order to purchase a variety of products and services 306 using through product-and-service-ordering interfaces provided on their cell phones. Similarly, mobile-phone users can access, using their cell phones, a wide variety of different information-provision services 308, allowing mobile-phone users to obtain and display information related to financial transactions, stock prices and purchases, weather reports, maps, and a large variety of other types of information.

This large expansion of capabilities and services accessible to a mobile-phone user has spawned enormous changes in traditional commercial and financial activities and service provision, and has created or facilitated many different markets and service networks. However, while mobile-phone users routinely employ their cell phones to exchange information with other mobile-phone users, mobile-phone users carry out exchange of value largely with carrier services, financial institutions, and commercial enterprises. In other words, a mobile-phone user can currently exchange voice signals and short text messages with a much larger number of individuals and institutions than the rather limited number of institutions with which a user can engage in value exchange. Mobile-phone users, carrier-service providers, and third-party software developers and service providers have all recognized a need for expanding the number of individuals and institutions with which mobile-phone users can exchange value and other abstract quantities, in addition to exchanging voice signals and text messages, in order to create and facilitate a broader range of markets and transaction-based networks.

### SUMMARY OF THE INVENTION

Embodiments of the present invention are directed to enhancing mobile-phone networks to allow mobile-phone users to exchange value among themselves through mobile-phone networks. In certain embodiments of the present invention, mobile-phone users exchange value among themselves by exchanging minutes of mobile-phone usage purchased by the mobile-phone users from their carrier-service providers. Minutes-based value exchanges are particularly useful in developing countries, where users may not have bank accounts, and where the overheads associated with traditional financial transactions are too great to allow for use of traditional-financial-transaction services to carry out the many relatively low-value transactions in which mobile-phone users may wish to engage. The exchange of minutes among mobile-phone users, as well as between mobile-phone users and commercial enterprises, can facilitate currently existing small-value-exchange markets as well as create whole new types of markets previously impractical due to the high overheads associated with value exchanges through traditional-financial-transaction services.

### BRIEF DESCRIPTION OF THE DRAWINGS

FIG. 1 shows a relatively high-level diagram of a generalized mobile-phone communications system.

FIG. 2 illustrates a useful abstraction of generalized mobile-phone systems and platforms.

FIG. 3 illustrates a small number of the various services that a mobile-phone user can currently access via the user's mobile phone and the mobile-phone network.

FIG. 4 illustrates the underlying concept of many embodiments of the present invention.

FIG. 5 provides a high-level, block diagram of various embodiments of the present invention.

FIG. 6 illustrates one particular implementation of the value-transfer services that represent embodiments of the present invention.

FIG. 7 illustrates the locations of various types of stored value within the value-transfer-service-enhanced mobile-phone network illustrated in FIG. 5.

FIG. 8 illustrates interfaces involved in value exchange through the value-transfer service.

FIGS. 9A-E illustrate a generalized value-exchange transaction session in which a carrier-service subscriber, or client, accesses value-transfer services for transferring value.

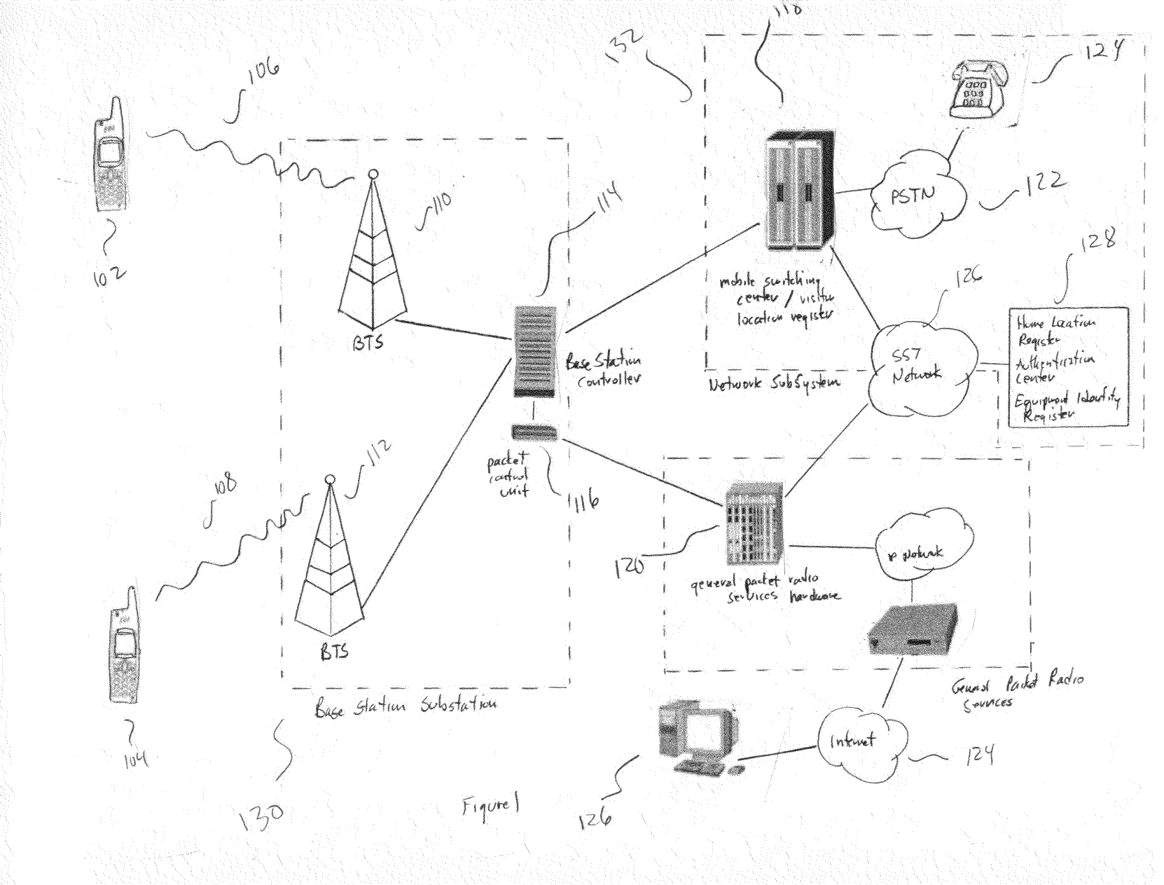

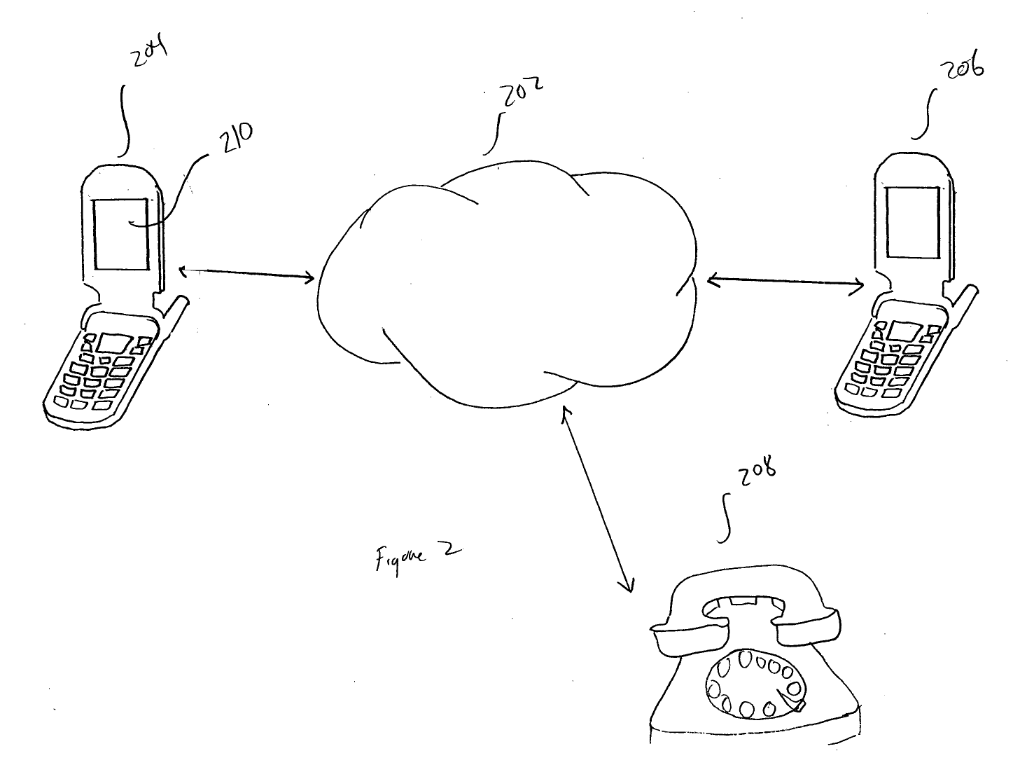

### DETAILED DESCRIPTION OF THE INVENTION

Embodiments of the present invention are directed to expanding the ability of mobile-phone users to exchange value in order to facilitate value-based transactions and various markets and service networks. As discussed in the background of the invention section, carrier-service providers, in combination with financial and commercial institutions, have begun to provide a variety of services to mobile-phone users, such as banking services, product ordering services, and other such services in which value is exchanged. However, currently, the value-exchange services are generally conducted between a single mobile-phone user, also referred to as a “carrier-services subscriber,” and a commercial enterprise or financial institution. While these expanded value-exchange-based services have greatly facilitated, and made more efficient, many existing markets, there is a potentially far larger set of markets that can be facilitated and created by economically efficient value-exchange-based transactions among mobile-phone users and between mobile-phone users and small businesses, particularly in developing countries.

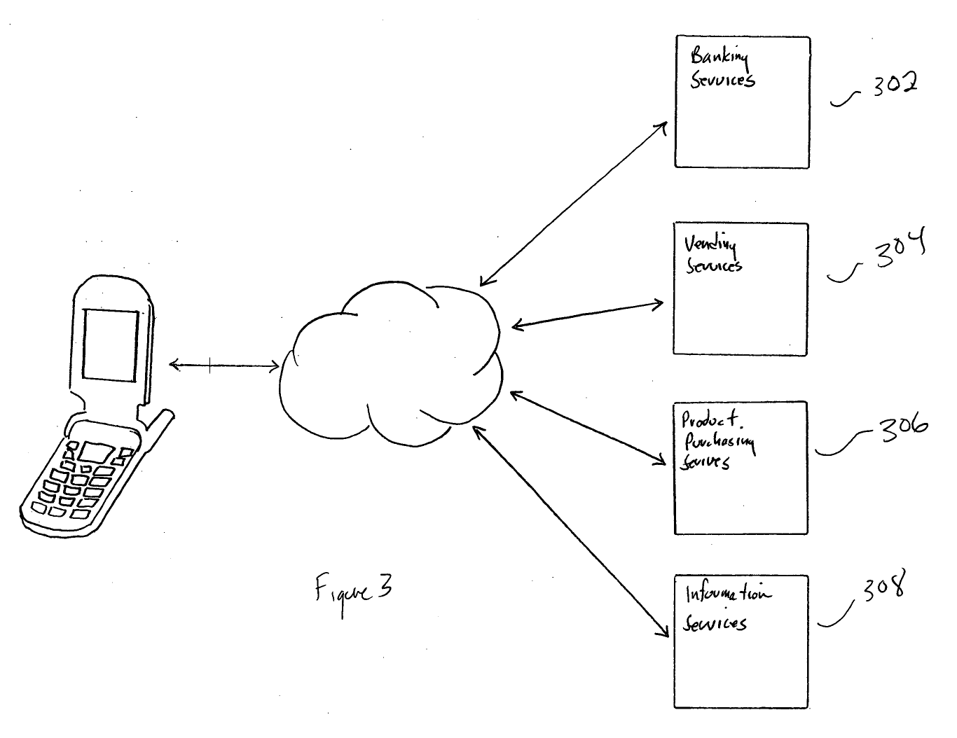

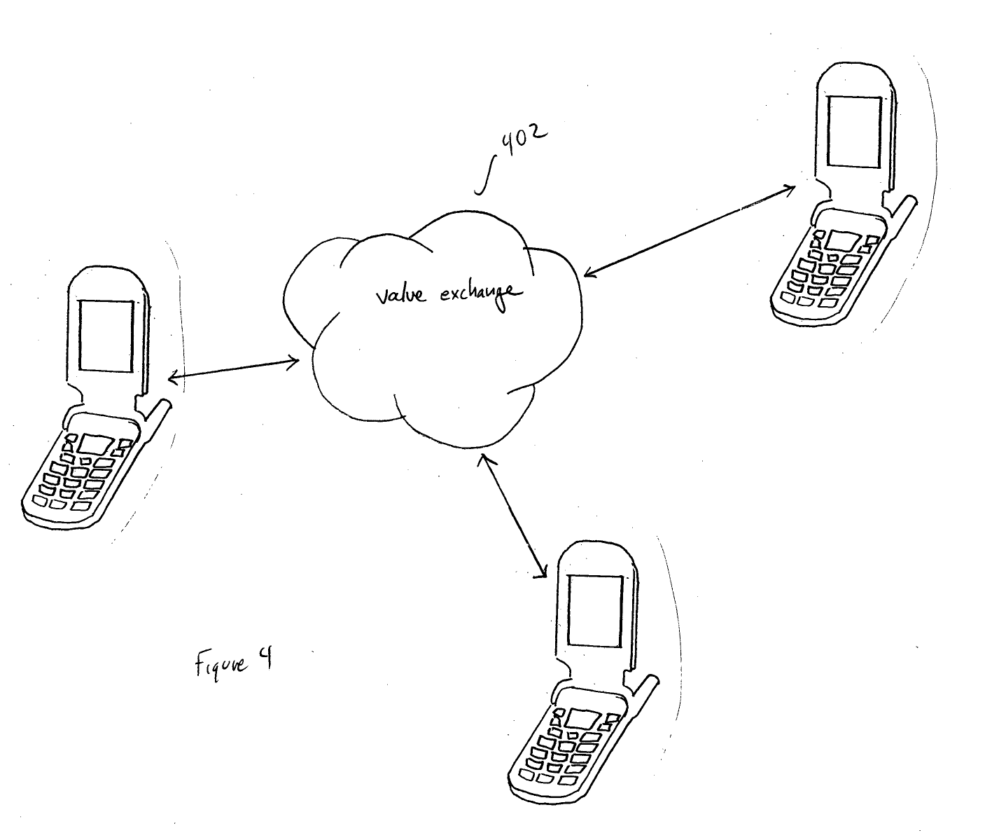

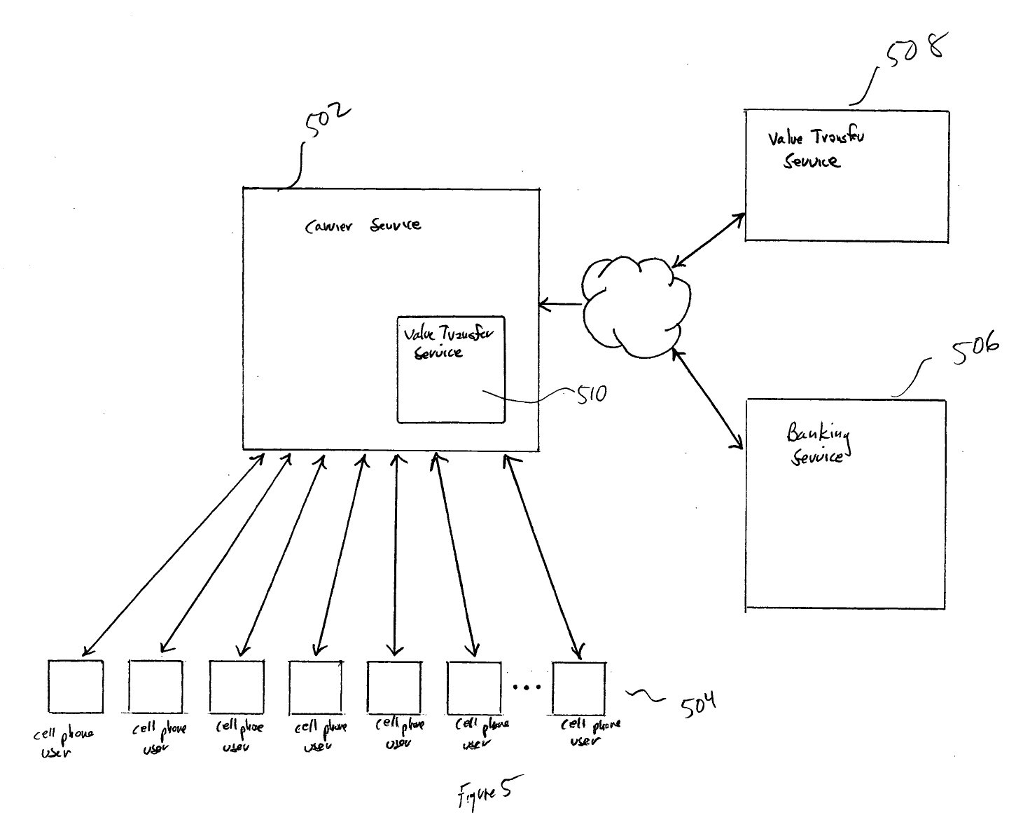

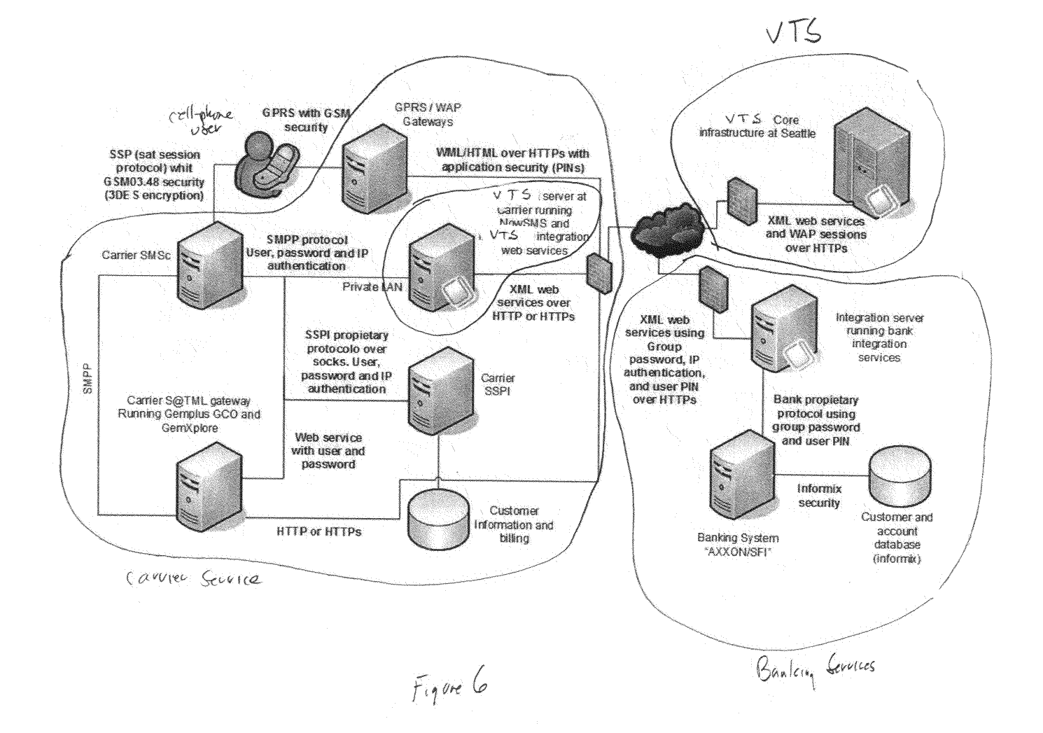

FIG. 4 illustrates the underlying concept of many embodiments of the present invention. As shown in FIG. 4, embodiments of the present invention enable mobile-phone users to exchange value among themselves through a mobile-phone network. In other words, the mobile-phone network becomes a value-exchange medium 402. This concept can be contrasted with current communications and information exchange provided by mobile-phone networks, as shown in FIGS. 2 and 3. As shown in FIG. 2, mobile-phone networks currently allow mobile-phone users to easily exchange voice signals and short text messages among themselves through the mobile-phone-network communications medium 202. As shown in FIG. 3, many mobile-phone networks, in combination with sophisticated financial and commercial institutions with resources to develop and deploy specific applications for services provision, allow mobile-phone users to conduct certain value-exchange-based transactions with financial institutions and commercial enterprises. Thus, as shown in FIG. 3, value exchange is currently limited to user-to-institution connections, while voice-signal and short-text-message communications, as shown in FIG. 2, can be carried out among mobile-phone users as well as between mobile-phone users and institutions. Embodiments of the present invention, as shown in FIG. 4, enhance mobile-phone networks so that mobile-phone networks can serve as value-exchange media to allow mobile-phone users to exchange value amongst themselves, as well as with small businesses and larger institutions.

There are a variety of different approaches that might be undertaken in order to expand mobile-phone networks into broadly-accessible value-exchange media. For example, one method would potentially entail carrier-service providers becoming financial institutions, and carrying out fund transfers on behalf of subscribers in place of traditional financial institutions. However, this approach would run afoul of many governmental regulations, in many parts of the world, and would also require carrier-service providers to develop and maintain complex financial systems currently outside their expertise. Another approach is to standardize carrier-service interfaces and banking-services interfaces so that mobile-phone users can be seamlessly routed, by carrier-service providers, to proper banking-services interfaces to facilitate fund transfers between different banks and different account holders. Such standardization and interface-development tasks are, however, complex, time consuming, and expensive, and may be difficult to implement in view of regulatory infrastructure and differences between various mobile-phone networks, carrier services, and banking services.

Embodiments of the present invention represent a third, economical, and practical approach to transforming mobile-telephone networks into generalized value-exchange media. Carrier services necessarily create and maintain accounts for carrier-service subscribers. These accounts, in many parts of the world, may store some number of prepaid minutes of use that the carrier-service subscriber has purchased from the carrier service, or may alternatively represent minutes-based credit accounts. Minutes accounts are debited by the duration, in minutes or seconds, of each connection made by a mobile-phone user, such as a voice call or transmission of a short text message. A minutes account is therefore a form of stored value. At any given instant in time, minutes can be converted to monetary values, and monetary values can be converted to minutes. Carrier services therefore already provide a means for carrier-service subscribers to purchase minutes from the carrier service and to spend purchased minutes by using the carrier-service-subscriber's mobile phone. Embodiments of the present invention allow carrier-service subscribers, or mobile-phone users, to transfer minutes to another mobile-phone user, as well as to small businesses and other institutions, who agree to accept minutes in exchange for products and services. In many embodiments of the present invention, traditional banking services are also offered, through the mobile-phone network, to mobile-phone users. However, for small-value transactions, a mobile-phone user can transfer value to another mobile-phone user or institution through the carrier service, without invoking additional banking services and banking-services fees, by transferring minutes, rather than undertaking a traditional funds transfer. In developing countries, where many people do not have bank accounts, a minutes-based electronic value-exchange medium may not only be the most efficient means for carrying out transaction, but may, in fact, be the only secure medium for value exchange available to most people.

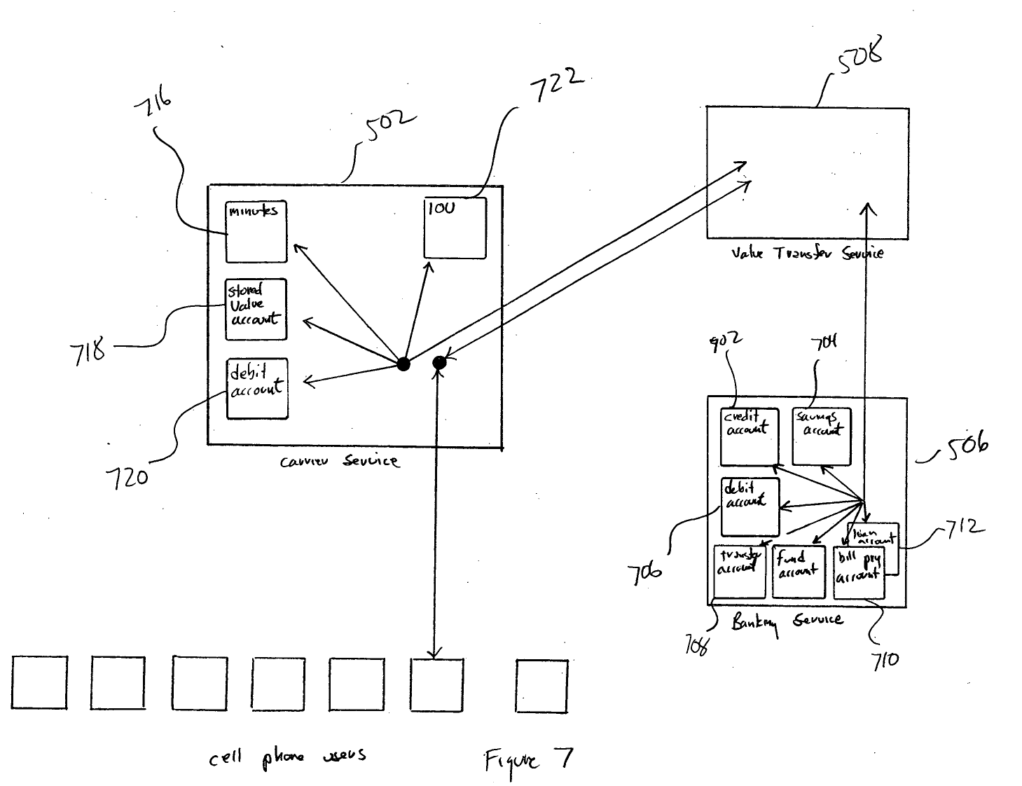

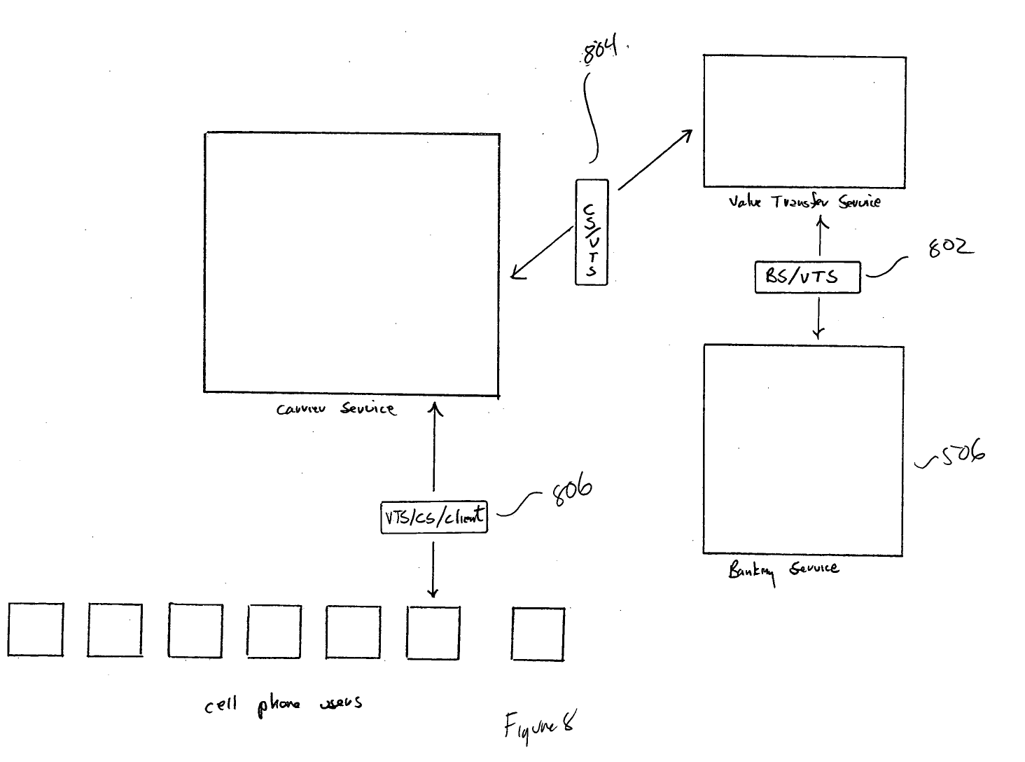

FIG. 5 provides a high-level, block diagram of various embodiments of the present invention. As shown in FIG. 5, a traditional carrier-service provider that provides and manages a mobile-phone network 502 provides carrier service to a large number of mobile-phone users, such as mobile-phone user 504. The carrier service can connect mobile-phone users to traditional banking services 506, but unlike in current systems, banking services are provided through an intermediary value-transfer service 508. The value-transfer service includes a separate, remote value-transfer-service center 508, and also maintains a value-transfer-service component 510 internally within the carrier service as well as value-transfer-service applications within each cell phone used for value-transfer exchanges mediated by the value-transfer service 508.

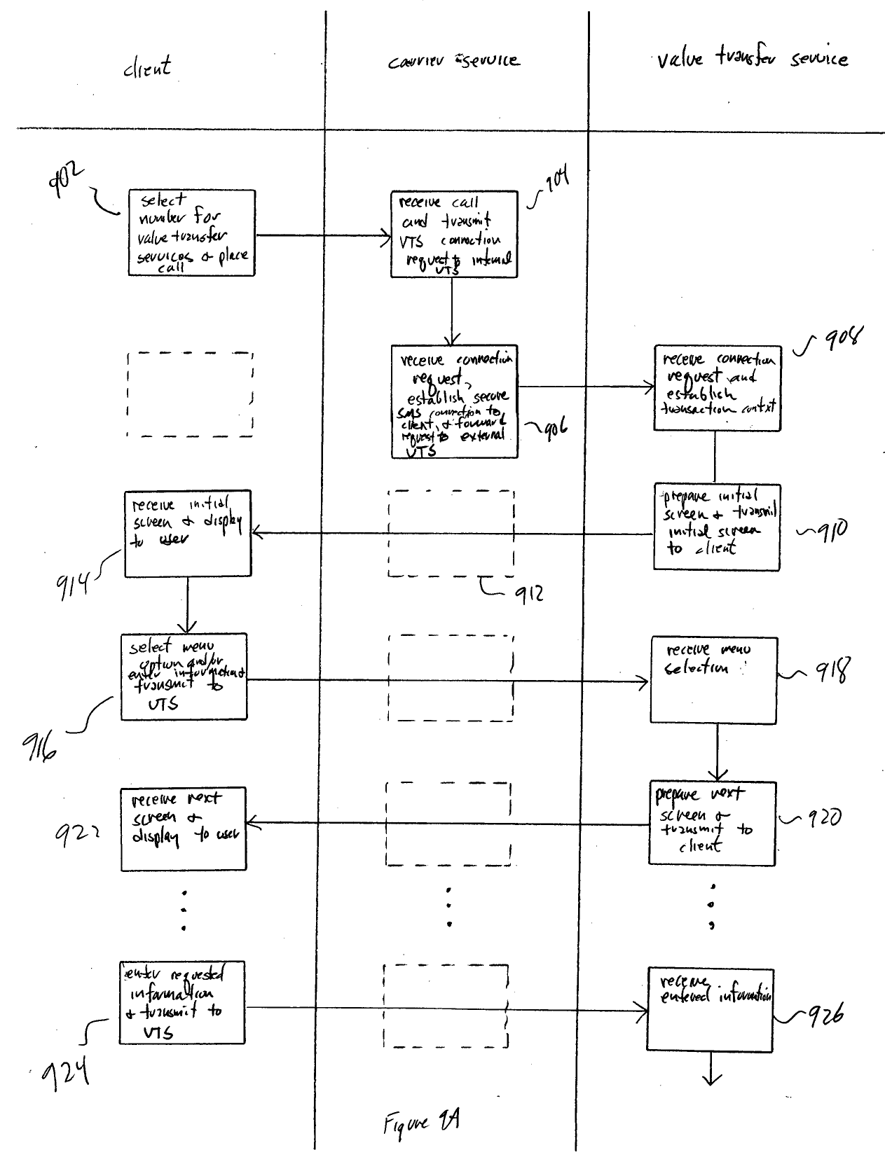

FIG. 6 illustrates one particular implementation of the value-transfer services that represent embodiments of the present invention. In FIG. 6, specific hardware components are mapped to the generalized blocks shown in FIG. 5. Of course, there are a wide variety of different possible implementations of the present invention, using different protocols, communications hardware, computing devices, servers, and communications systems.

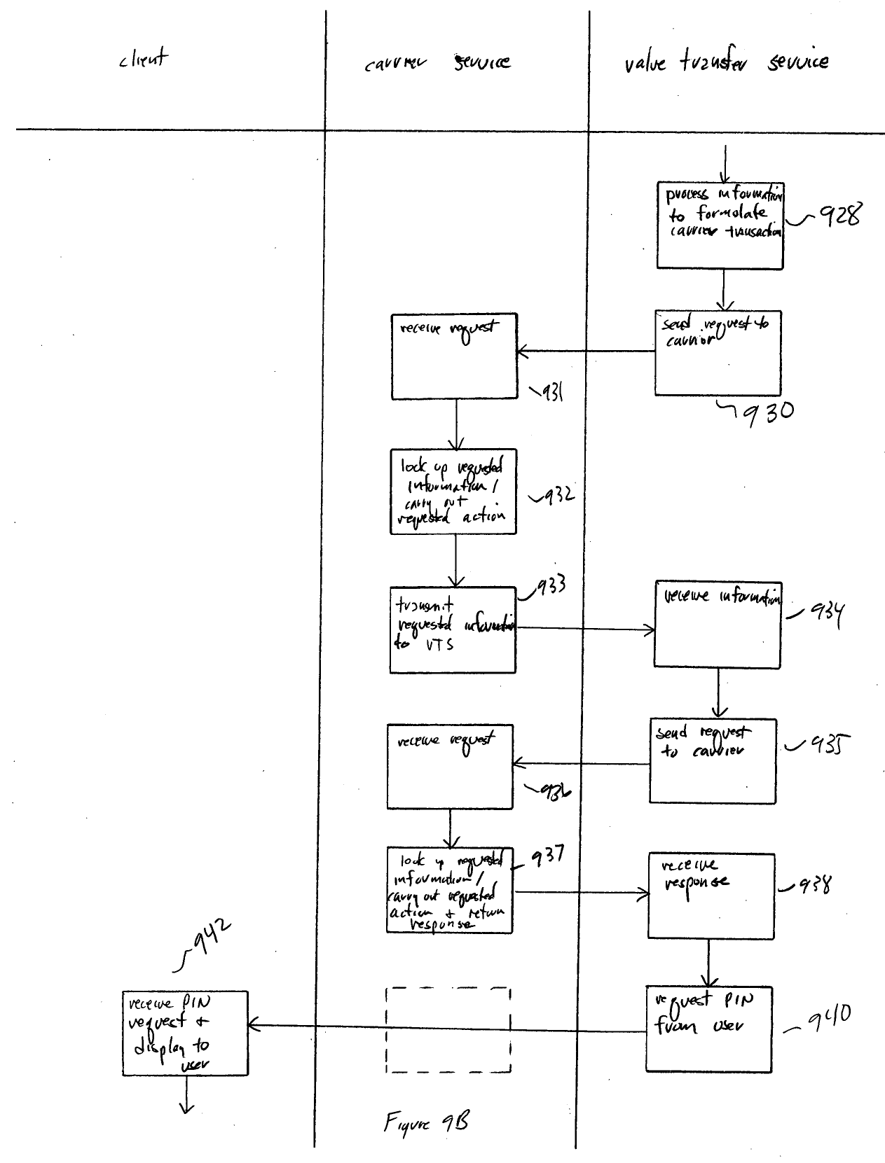

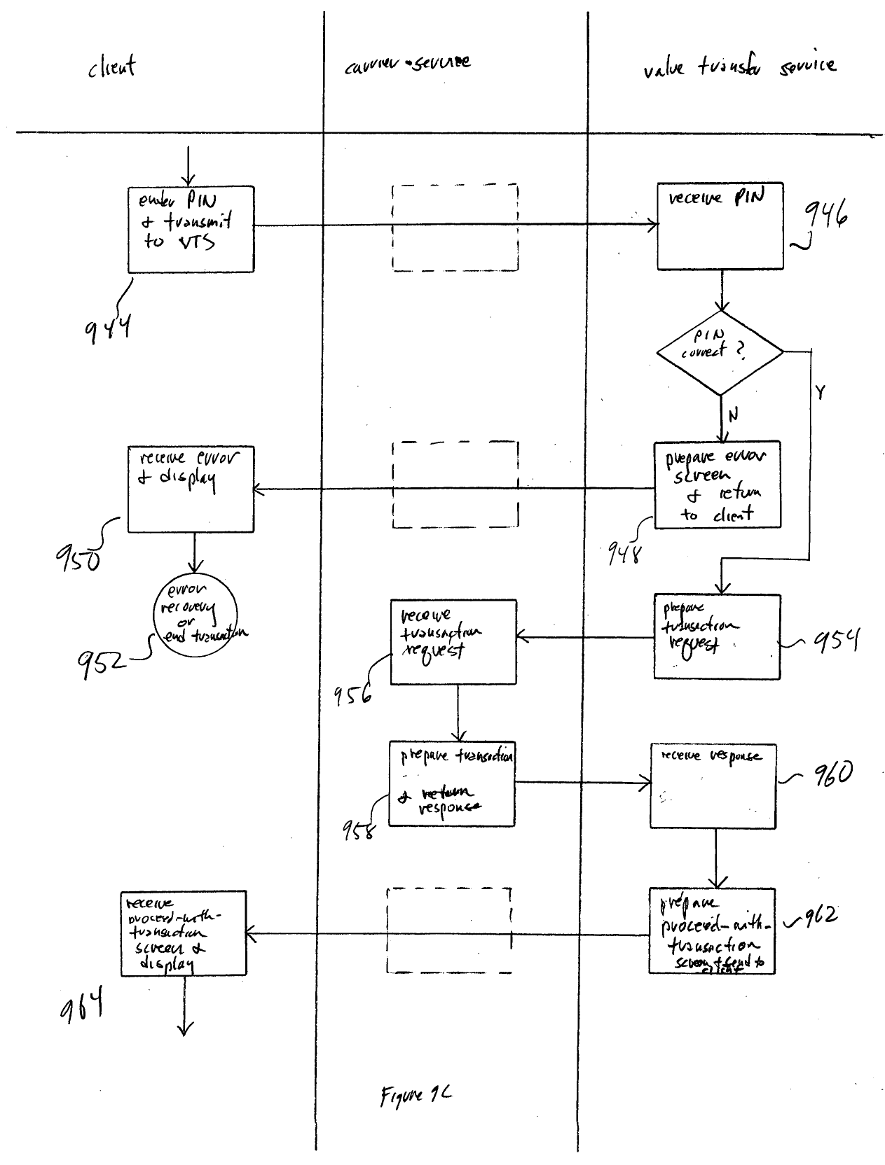

FIG. 7 illustrates the locations of various types of stored value within the value-transfer-service-enhanced mobile-phone network illustrated in FIG. 5. As shown in FIG. 7, the banking service 506 may maintain a variety of different types of accounts on behalf of any particular mobile-phone user. Such accounts include credit accounts 702, savings accounts 704, debit accounts 706, fund-transfer accounts 708, specific bill-paying accounts 710, loan accounts 712, and a variety of other different types of banking accounts and services. Similarly, the carrier service 502 may maintain different types of stored value on behalf of carrier-service subscribers. These accounts include minutes accounts 716, stored-value accounts 718, debit accounts 720, and IOU, or loan, accounts 722. The value transfer service 508 does not store or maintain any type of stored value, but instead provides the interconnections, interfaces, and application programs that allow a mobile-phone user to access stored value within the carrier service or banking service and to transfer stored value from one of the mobile-phone user's accounts to another, as well as allowing the mobile-phone user to transfer certain types of stored value, most particularly minutes, to the carrier-service account of another mobile-phone user, small business, or other institution.

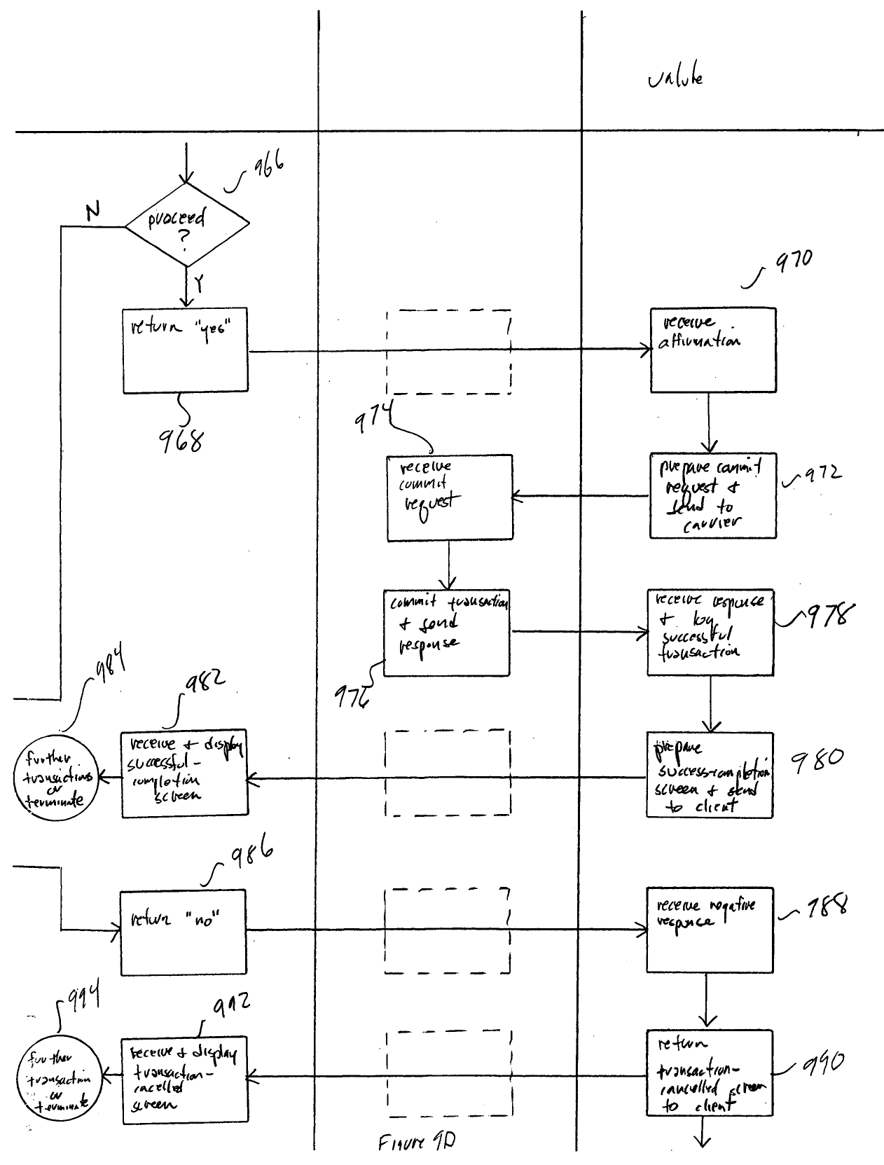

In certain embodiments of the present invention, a carrier-service's subscriber accesses value-transfer services by calling a specific number, with the call transferred by the carrier service to the internal value-transfer-service component (510 in FIG. 5) within the carrier service 502. The value-transfer-service component then establishes a transaction session between the mobile-phone user and the value-transfer-service center 508. FIG. 8 illustrates interfaces involved in value exchange through the value-transfer service. The value-transfer service interfaces through a banking interface 802 to banking services 506. The banking-services interface 802 may vary from one particular banking service to another. The value-transfer service interfaces to various carrier services through carrier-service interfaces 804. A mobile-phone user interfaces to the value-transfer service through a value-transfer-service/carrier-service/client interface (“VTS/CS/client interface”) 806.

The banking-services interface 802 provides a collection of calls, or functions, to allow the value-transfer service to identify a mobile-phone user to the banking service, authorize access by the mobile-phone user to the banking service, identify accounts maintained by the banking service on behalf of a particular mobile-phone user, and various functions and calls needed to allow the value-transfer service to transfer funds and manage accounts on behalf of the mobile-phone user. Similarly, the carrier-service interface 804 provides functions and calls that allow the value-transfer service to access mobile-phone-user carrier-service accounts, manage those accounts, and transfer value between accounts on behalf of a mobile-phone user. Both the banking-services and carrier-services interfaces 802 and 804 are implemented as special-purpose enterprise applications that run on high-end computing platforms within the value-transfer-service center (508 in FIG. 5), the carrier service (502 in FIG. 5), and the banking service (506 in FIG. 5).

The VTS/CS/client interface 806 is implemented, in certain embodiments of the present invention, as SIM applications that run on mobile phones and that communicate with value-transfer-service servers within the carrier service and the value-transfer-service center. The VTS/CS/client interface allows a mobile-phone user to create any of the various different types of carrier-service-provided accounts, including stored value accounts, debit accounts, minutes accounts, and IOU accounts, to transfer stored value between these different types of accounts, with proper conversion, to add funds to accounts or purchase minutes, and to transfer minutes from the mobile-phone user's minutes account to the minutes account of another mobile-phone user, small business, or institution. In addition, the VTS/CS/client interface 806 provides similar functionalities to allow a mobile-phone user to access and manage additional banking accounts provided by a banking service. The value-transfer service provides real-time transaction connections through the carrier service to mobile-phone users, allowing the value-transfer service to carry out all of the services provided to a mobile-phone user through the VTS/CS/client interface on behalf of mobile-phone users via the carrier-services interface 804 and the banking-services interface 802.

The value-transfer services of many embodiments of the present invention provide a uniform constellation of services to a variety of different carrier services and banking services in order to create a large, flexible value-exchange network comprising multiple carrier services and banking services. In addition, the value-transfer service may provide additional authentication and security services, more stringent and more transaction-oriented than those provided either by the carrier services or by the banking services.

From the standpoint of a mobile-phone user, the value-transfer services obtained through the VTS/CS/client interface allow the mobile-phone user to conduct extremely efficient, low-overhead value exchange with other mobile-phone users, small businesses, and institutions. A mobile-phone user can, for example, pay for a taxi service by transferring an agreed-upon number of minutes from the mobile-phone user's minutes account to the taxi driver's minutes account. All such transactions are logged by the value transfer service, both for regulatory and tax purposes, as well as to provide a faithful and robust transaction record that can assist in subsequent dispute resolution, transaction verification, and account-balance verification. Minutes-based value exchange is a desirable feature that can be offered by carrier-service providers in order to promote long-term relationships with subscribers and/or to generate additional revenues through modest service charges. Small-value transactions, between mobile-phone users and small businesses, and among mobile-phone users, that are conducted through the value-transfer system are far more secure and verifiable than cash-based transactions.

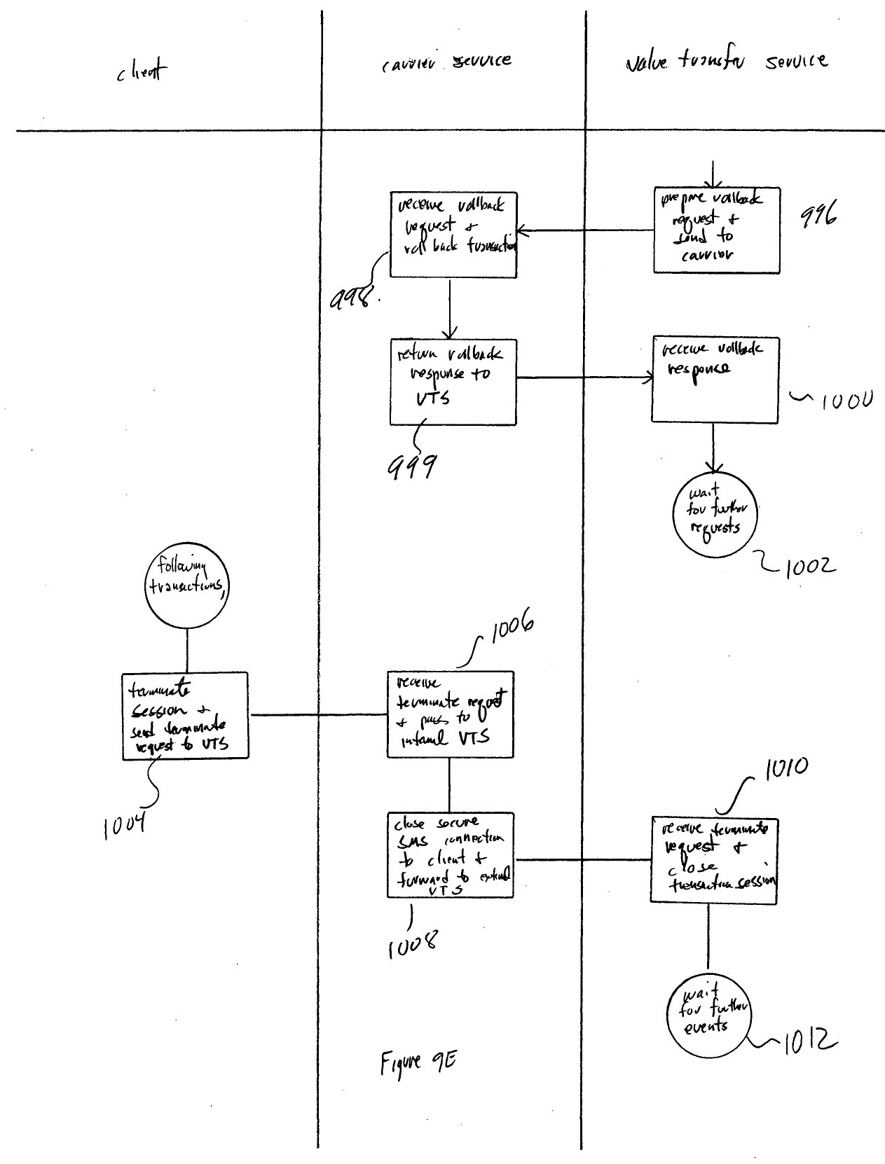

Perhaps the best description of how the value-transfer service serves as an intermediary to facilitate a generalized value-exchange-based transaction is to follow, in detail, an example, of a generalized, value-exchange transaction from the standpoint of a mobile-phone user, or client, a carrier service, and the value-transfer service. FIGS. 9A-E illustrate a generalized value-exchange transaction session in which a carrier-service subscriber, or client, accesses value-transfer services for transferring value.

In step 902, the client places a call, using the client's mobile phone, to the value-transfer services. In step 904, the carrier service receives the call, through normal GSM mechanisms, and forwards the call to the internal VTS component within the carrier-services facility. In step 906, the internal VTS component within a carrier-service facility receives a connection request corresponding to the call from the carrier service, and establishes a secure SMS-based connection to the client. In addition, the internal VTS component within the carrier service forwards a connection request to the value-transfer-service center. The value-transfer-service center, in step 908, receives the connection request and establishes a transaction context on behalf of the carrier-service subscriber, or client. As part of establishing the transaction context, the value-transfer service may interact with a carrier service, through the carrier-service's interface (804 in FIG. 8) in order to establish the identity of the carrier-service's subscriber and verify authentication of the mobile phone by the carrier service.

Next, in step 910, the value-transfer service can prepare an initial display screen and transmit the initial display screen to the client. In FIGS. 9A-E, transmission of information between the value-transfer service and the client are shown as passing through the carrier service, as represented in FIGS. 9A-E as dashed boxes, such as dashed box 912. In other words, the value-transfer service does not directly transmit information to the client, but instead transmits information to the carrier-service for forwarding, by the carrier service, to the client's mobile phone. Rather than preparing an initial screen, the value-transfer service may alternatively simply transmit a transaction-context-established message to the SIM application running on the client's mobile phone, which can then display a stored, initial screen. In either case, in step 914, the client's mobile phone displays an initial screen to the client. The client can select menu options or navigate to additional screens by input to the mobile phone, in step 916, and transmission of the input data back to the value-transfer service. The value-transfer service receives the input data, in step 918, and may then prepare a next screen, in step 920, to transmit to the client for display on the client's mobile phone, in step 922. Thus, the client and the value-transfer service may carry out a menu-driven dialog, by such steps, in order to allow the client to navigate to an appropriate screen for requesting a particular type of value transfer.

When that proper screen is displayed to the client, in step 924, the client enters requested information, such as the number of minutes to transfer and the mobile-phone number of the mobile-phone user to which the client wishes to transfer the minutes, and the information is returned to the value-transfer service. Upon receiving that information, in step 926, the value-transfer service processes the information, in step 928 (FIG. 9B), and then carries out a dialog, in steps 930-938, with the carrier service through the carrier-service interface (804 in FIG. 8) in order to access the client's account, verify sufficient balance for the transfer, determine that the mobile-phone-user to which the client wishes to transfer minutes exists, and carry other such information-related tasks.

At step 938, the value-transfer service has determined that the requested transfer of minutes is valid and can be carried out, and therefore, in step 940, sends a personal identification number (“PIN”) request screen to the client. In step 942, the client receives the PIN request and displays the PIN request to the user. In step 944 (FIG. 9C), the client enters the client's PIN number and transmits the PIN number back to the value-transfer service. In step 946, the value-transfer service receives the PIN and determines, by accessing a stored, authentication database, whether the PIN is correct. If not, then in step 948, the value-transfer service prepares an error screen and returns it to the client, where it is displayed to the user in step 950. At this point, any of various error recovery or transaction ending dialogs may occur, as represented by step 952. If the PIN is correct, then, in step 954, the value-transfer service prepares a value-transfer request and forwards that request, through the carrier-services interface (804 in FIG. 8), to the carrier service. In step 956, the carrier service receives the transaction request and, in step 958, prepares the transaction and returns a successful transaction-preparation response to the value-transfer service. The value-transfer service receives the response, in step 960, and prepares a proceed-with-transaction screen in step 962 that is transmitted back to the client. In step 964, the client receives the proceed-with-transaction screen and displays the proceed-with-transaction screen to the user, who, in step 966 (FIG. 9D) can determine whether or not to proceed with the transaction by entering an appropriate input to the proceed-with-transaction screen.

When the user indicates a desire to continue with the transaction, in step 968, the positive response is returned to the value-transfer service. The value-transfer service, in step 970, receives the affirmative response and, in step 972, prepares a commit request to send to the carrier services. The carrier services, in step 974, receives the commit request and commits the transaction, in step 976, returning a successful commit response to the value-transfer service. The value-transfer service, in step 978, receives the successful response and, in step 980, prepares a successful completion screen to send to the client. The client receives the successful completion screen, in step 982, and displays the successful completion screen to the user, who may then, as represented by step 984, carry out additional transactions through additional dialogs with the value-transfer service.

By contrast, if the user decides not to proceed with the transaction then, in step 986, the user returns a negative response to the value-transfer service. In step 988, the value-transfer service receives the negative response and, in step 990, prepares a transaction-cancelled screen to return to the client. In step 992, the client receives the transaction-cancelled screen and displays it to the user, who may then carry out further transactions with the value-transfer service, or choose to terminate the transaction session, as represented by step 994. Then, in step 996 (FIG. 9E), the value-transfer service prepares a rollback request and sends the rollback request to the carrier which, in step 998, receives the rollback request and rolls back the prepared transaction in step 999, returning a rollback-success response to the value-transfer service which, in step 1000, receives the rollback response and proceeds to wait, in step 1002, for further requests.

Eventually, the client inputs an indication to the mobile phone that the client wishes to terminate the transaction session, in step 1004. The carrier services receives the indication, in step 1006, and forwards that indication to the internal VTS which, in step 1008, closes the secure SMS connection to the client and forwards the termination request to the VTS center. The VTS center 1010 receives the termination request and closes the transaction session in step 1010. The value transfer service then waits for further requests and events, in step 1012.

Of course, there are many different possible implementations of a generalized value-exchange transaction. For example, display screens are shown being prepared by the value-transfer service, in FIGS. 9A-E, while, in alternative embodiments, the display screens may be already prepared and stored within the mobile phone or in the internal value-transfer-services component within the carrier service. In the exemplary value-exchange-based transaction in FIGS. 9A-E, the recipient of the value-transfer is not contacted in the transaction, but, in alternative embodiments, the recipient may be contacted by the value-transfer service through the carrier service in order to agree or authorize the transfer. Various embodiments of the present invention provide for a wide variety of different value-exchange-based transactions, including conversions of minutes to monetary value, transfer of value between the user's accounts, and transfer of value between one user's accounts and those of another, in addition to the minutes transfers discussed above. As with any system, the value-exchange-enabling systems of the present invention can be implemented in any number of different software programs on any number of different software-program-execution platforms on a wide variety of different types of hardware interconnected with different types of communications media. The additional different types of accounts and stored value may be created and maintained on behalf of mobile-phone users, and a wide variety of different types of interfaces can be designed and implemented, to allow mobile-phone users to and transfer funds from and to the accounts.

Although the present invention has been described in terms of particular embodiments, it is not intended that the invention be limited to these embodiments. Modifications within the spirit of the invention will be apparent to those skilled in the art. For example, as discussed above, an essentially limitless number of different implementations can be devised, using different programming languages, program-execution platforms, communications networks, communications hardware, and other different devices and methods. Storage and transfer of many different types of stored value may be implemented by carrier-service providers, and provided to carrier-service subscribers within a variety of subscription plans.

The foregoing description, for purposes of explanation, used specific nomenclature to provide a thorough understanding of the invention. However, it will be apparent to one skilled in the art that the specific details are not required in order to practice the invention. The foregoing descriptions of specific embodiments of the present invention are presented for purpose of illustration and description. They are not intended to be exhaustive or to limit the invention to the precise forms disclosed. Many modifications and variations are possible in view of the above teachings. The embodiments are shown and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents:

1. A method for providing value-exchange through a mobile-telephone network, the method comprising:
storing minutes in a minutes account for mobile-telephone-network users; and
providing an interface to a first mobile-telephone-network user that allows the first mobile-telephone-network user to transfer minutes from the first mobile-telephone-network user's minutes account to a minutes account belonging to a second mobile-telephone-network user.

2. The method of claim 1 wherein the interface provided to a first mobile-telephone-network user allows the mobile-telephone-network user to create a minutes accounts, purchase minutes through cash transactions or fund transfers and add the purchased minutes to the minutes account, convert minutes to other form of value and transferring the converted minutes to other stored-value accounts.

3. The method of claim 1 wherein the interface allows the first mobile-telephone-network user to transfer minutes from the first mobile-telephone-network user's minutes account to small businesses, commercial enterprises, and financial institutions, in addition to a minutes account belonging to a second mobile-telephone-network user.

4. The method of claim 1 wherein the minutes account is maintained by a carrier-service provider.

5. The method of claim 4 wherein minutes are transferred from a first minutes account to one of a second minutes account, a small business, a commercial enterprise, or a financial institution by a value-transfer service that communicates with the mobile-telephone-network user through the carrier service, providing data for display by the user interface on the mobile-telephone-network user's mobile telephone and receiving data input through the user interface from the mobile-telephone-network user's mobile telephone, and interfacing with the carrier service on behalf of the mobile-telephone-network user through a carrier-services interface.

6. A system for electronic value exchange, the system comprising:
a first mobile phone;
a second mobile phone; and
a carrier service that
interconnects the first mobile phone with the second mobile phone for exchange of voice signals and text messages;
maintains a first minutes account on behalf of a first user of the first mobile phone;
maintains a second minutes account on behalf of a second user of the second mobile phone; and
a user interface that allows the first user to transfer minutes from the first user's minutes account to the second user's minutes account.

7. The system of claim 6 wherein the user interface is provided by a value-transfer service.

8. The system of claim 7 wherein the value-transfer service comprises:
value-transfer-service applications running on computing hardware within a value-transfer-service center;
a value-transfer-service server and applications running within the carrier service; and
value-transfer-service application programs running on the first and second mobile phones.

9. The system of claim 8 wherein the value transfer service, upon a request directed to the value transfer service by the carrier service in response to a call from the first user of first mobile phone, opens a transaction session with the first user of first mobile phone, carries out a dialogue with the first user in order to receive a minutes-transfer request from the first user, and interacts with the carrier service through a carrier service interface to carry out the requested minutes transfer on behalf of the first user.

10. The system of claim 6 wherein the user interface allows the first user to open a secure, text-message-based transaction session and request the minutes transfer from the first user's account to the second user's minutes account.

11. The system of claim 10 wherein the user interface requires the first user to supply a personal identification number in order to authorize the minutes transfer from the first user's account to the second user's minutes account.

12. The system of claim 10 wherein the user interface, after authorizing and preparing the minutes transfer from the first user's account to the second user's minutes account, allows the first user to either accept the minutes transfer or decline the minutes transfer.

13. The system of claim 6 wherein the user interface allows a carrier-service subscriber to create a minutes account, transfer minutes from the minutes accounts to other stored-values accounts, transfer stored value from other stored-value accounts to the minutes account, and purchase minutes for addition to the minutes account, in addition to transferring minutes to another carrier-service subscriber.

15. A system for electronic value exchange, the system comprising:
a number of mobile phones;
a carrier service that
interconnects the number of mobile phones for exchange of voice signals and text messages; and
maintains minutes accounts, stored value accounts, debit accounts, and IOU accounts on behalf of carrier-service subscribers; and
a user interface that allows carrier-service subscribers to
create minutes accounts, IOU accounts, and stored-value accounts,
transfer minutes and other stored value among the various accounts belonging to a carrier-service subscriber, and
transfer minutes from one carrier-service subscriber's minutes account to another carrier-service subscriber's minutes account.
